(19) United States
(12) Patent Application Publication
(10) Pub. No.: US 2021/0378331 A1
(43) Pub. Date: Dec. 9, 2021

(54) LEAD GOWN SUPPORT

(71) Applicants: Ghassan S. Kassab, La Jolla, CA (US); Terry A. Hubbard, Valley Center, CA (US)

(72) Inventors: Ghassan S. Kassab, La Jolla, CA (US); Terry A. Hubbard, Valley Center, CA (US)

(21) Appl. No.: 17/405,463

(22) Filed: Aug. 18, 2021

Related U.S. Application Data
(63) Continuation of application No. 17/157,267, filed on Jan. 25, 2021.
(60) Provisional application No. 62/965,157, filed on Jan. 23, 2020.

(51) Int. Cl. A41D 13/12; G21F 3/02

(52) U.S. Cl. CPC A41D 13/129; G21F 3/02; A41D 13/1245

(57) ABSTRACT

A wearable support device for use with heavy clothing such as a lead gown or apron is disclosed. The device relieves the shoulders and back of weight by transferring the weight of the lead gown to the waist and hips of the wearers. The device comprises a strap that supports the gown and a bolster disposed on the strap that is located distally. The lead gown is word over the waistband such that it rests upon the bolster. A closure is used to secure the device around the waist of the wearer, and an adjustment can be located on the strap for ensuring a snug fit. The bolster is made of a semi-firm material that is sufficiently firm to support a lead gown and flexible to conform comfortably to the waist of a wearer.

### PRIORITY

The present patent application is related to as a continuation-in-part of, and claims the priority benefit of, U.S. patent application Ser. No. 17/157,267, filed on Jan. 25, 2021, which is related to, and claims the priority benefit of, U.S. Provisional Patent Application Ser. No. 62/965,157, filed on Jan. 23, 2020, the contents of which are hereby incorporated by reference in their entirety into this disclosure.

### BACKGROUND

A number of important medical procedures expose both the patient and the medical team to X-ray radiation. For example, fluoroscopy is an imaging technique that uses relatively high doses of radiation and is used during minimally invasive intravascular procedures to provide live images of the patient. With the aid of fluoroscopy, a team of skilled physicians and nurses can perform life saving procedures such as deploying a stent, applying drugs to a specific area of the patient vasculature, tissue ablation, balloon angioplasty, vessel anastomosis, etc.

Medical personnel participating in the procedure require protective clothing, otherwise the repeated exposure to radiation would be harmful. Thus they wear lead gowns/aprons, among other protective equipment, to mitigate their radiation exposure.

Protective lead clothing can weigh up to and even exceed 17 pounds. Such lead clothing is usually constructed having shoulder straps and a hole for the head so that it may be draped over the torso and rest on the shoulders of the wearer. Thus when in a standing position, the weight of the lead apron is concentrated on the shoulders. When the wearer is leaning slightly forward, such as over an operating table, the weight of the lead clothing is also directed toward the upper back area. The weight and bulk of the lead clothing can throw the wearer off balance and hinder smooth movement. In both positions, the additional weight is uncomfortable and over time becomes quite painful. The repeated use of lead clothing and body positioning leads to chronic injury. Such injuries become permanent disabilities and are career ending for physicians and medical personnel. As a result, these skilled physicians and medical personnel are forced to retire early and are unable to continue treating patients.

Thus there is a need for an improved device that can alleviate the impact of repeated wearing of heavy protective clothing so that such injury can be prevented; thereby extending the career of skilled physicians and allowing them to treat more patients.

### BRIEF SUMMARY

The disclosed embodiments solve the problems mentioned above. The devices transfer weight to a more durable body section, relieving users of significant pain and injury. Exemplary embodiments generally comprise a frame, a waistband and a cushion, that can be worn under a lead gown. In addition, lightweight materials are used in constructing the device to further reduce the weight carried by the user.

The present disclosure includes disclosure of a wearable device for supporting an article disposed onto the device and transferring the weight of the article away from the back and shoulders of the device user towards the larger muscles in the waist and hips.

In an exemplary embodiment, the device comprises: a waistband, a frame attached to the waistband, a cushion attached to the frame, the frame extending from the waistband upward and over the shoulders of a user.

In a further embodiment the cushion is disposed between the frame and the user.

In a further embodiment the frame is attached to the back of the waistband.

In a further embodiment the frame comprises two rigid stays.

In another exemplary embodiment the device comprises a waistband, a frame comprising a vertical portion and a horizontal portion, wherein a first end of the vertical portion is connected to the waistband and second end of the vertical portion is connected to the horizontal portion; and a cushion connected to the frame.

In a further embodiment the cushion is disposed toward the interior of the device.

In one embodiment, a wearable device for supporting an article of clothing disposed thereon comprises a waistband and a frame attached to the waistband; and the frame comprising a rigid material, the frame extending vertically away from the waistband and horizontally over the shoulders of a user, the frame configured to be spaced away from the user.

In one embodiment, a wearable device for supporting an article of clothing disposed thereon comprises a waistband and a frame attached to the waistband; and the frame comprising a rigid material, the frame extending vertically away from the waistband and horizontally over the shoulders of a user, the frame configured to be spaced away from the user and further comprising a cushion disposed toward the interior of the device and positioned on the frame between the frame and the user.

In one embodiment, a wearable device for supporting an article of clothing disposed thereon comprises a waistband and a frame attached to the waistband; and the frame comprising a rigid material, the frame is attached to a rear of the waistband and a second end of the frame is free floating.

In another embodiment of a device for supporting an article of clothing disposed thereon device the frame comprises at least one stay. The at least one stay may comprises a wide and flat shape. In another alternate embodiment, the frame comprises two stays, each of the two stays comprising being attached to a rear of the waistband on opposite sides of a midline of the waistband. The two stays may comprise contours shaped to approximate the form of a human torso.

In one embodiment of a device for supporting an article of clothing disposed thereon, the device can support an article of clothing support up to 17 pounds.

In one embodiment, a wearable device for supporting an article of clothing disposed thereon comprises a waistband; a rigid frame comprising a first vertical portion and a horizontal portion; and the first vertical portion connected to a rear of the waistband at a first end of the first vertical portion, the first vertical portion connected to the horizontal portion at a second end of the first vertical portion, and wherein the first vertical portion extends away from the waistband and the horizontal portion extending toward the front of the waistband.

In one embodiment, a wearable device for supporting an article of clothing disposed thereon, the frame is comprised of a lightweight rigid material comprising one or more of aluminum, carbon fiber, or titanium.

In one embodiment, a wearable device for supporting an article of clothing disposed thereon comprises a waistband; a rigid frame comprising a first vertical portion and a horizontal portion; and the first vertical portion connected to a rear of the waistband at a first end of the first vertical portion, the first vertical portion connected to the horizontal portion at a second end of the first vertical portion, and wherein the first vertical portion extends away from the waistband and the horizontal portion extending toward the front of the waistband; and a second vertical portion attached to the horizontal portion opposite the first vertical portion, the second vertical portion extending toward the waistband.

In one embodiment of a wearable device for supporting an article of clothing disposed thereon the end of the second vertical portion opposite the horizontal portion is free floating.

In one embodiment of a wearable device for supporting an article of clothing disposed thereon the frame is shaped to follow a contour of a human torso.

In one embodiment, a wearable device for supporting an article of clothing disposed thereon, comprises a waistband, a frame attached to the waistband; the frame extending from the waistband upward and over the shoulders of a user, the frame spaced away from the user; and at least one post element, the post element extending from the waistband to a supporting surface, and configured to aid in weight transfer and provide additional weight support.

In alternate embodiments, the post elements may be articulated. The post elements may be disposed on opposite sides of the waistband.

In alternate embodiments, the supporting surface may be a floor or an operating table.

In another exemplary embodiment the device comprises a waistband, a frame attached to the waistband, a cushion attached to the frame the frame extending from the waistband upward and over the shoulders of a user; and further comprising two post elements, the post elements extending from the waistband to a supporting surface.

In an embodiment of the present invention, a support device for supporting a heavy article of clothing, such as a lead apron or gown, worn over the support device comprises: a strap having a closure, the closure configured to connect the strap thereby forming a circumference; and a bolster disposed on the strap.

In a further embodiment of the present invention the bolster comprises a shelf on an upper side of the bolster. The bolster may also be comprised of a semi-firm material.

In a further embodiment of the present invention, the closure is attached at or near an end of the strap.

In a further embodiment of the present invention, the strap comprises two ends; the strap comprises a closed position; and wherein in the closed position the closure connects a point on or near each of the two ends of the strap together to form the circumference.

In a further embodiment of the present invention, an adjustment is disposed on the strap and configured to increase or decrease the circumference of the strap

In an alternate embodiment of the present invention, the bolster comprises at least one channel in the bolster.

In an embodiment of the present invention a support device for supporting a heavy article of clothing, such as a lead apron or gown, worn over the support device comprises: a circumferential strap having a closure; and a bolster disposed on the strap wherein the bolster is comprised of a semi-firm material and forms a shelf on the upper side of the bolster;

In a further embodiment of the present invention, the bolster is disposed on the circumferential strap diametrically opposite the closure.

In a further embodiment of the present invention, the bolster extends for at least half the circumference of the strap. In another embodiment, the bolster extends for more than half the circumference of the strap. In another embodiment, the bolster extends for less than half the circumference of the strap.

In further embodiments of the present invention, the bolster comprises a generally rectangular or elliptical shape.

In another embodiment, the bolster comprised of semi-firm material is sufficiently firm to support a lead apron on the shelf of the bolster. In another embodiment, the bolster is flexible.

In another embodiment, the strap is comprised of an inelastic material.

In an embodiment of the present invention, a method of using a support device for supporting a lead apron or gown comprises the steps of: positioning the support device around the waist of a wearer, wherein the support device comprises a bolster and the bolster has a shelf on an upper side of the bolster; positioning the bolster on the dorsal side of the wearer; and wearing a lead apron or gown after positioning the support device around the waist of a wearer, wherein at least part of the lead apron or gown rests upon the shelf of the bolster.

In a further embodiment of the present invention, the method of using a support device for supporting a lead apron or gown further comprises the step of positioning the support device around the waist of a wearer such that the bolster is covering the lower back of a wearer.

### BRIEF DESCRIPTION OF THE DRAWINGS

The disclosed embodiments and other features, advantages, and disclosures contained herein, and the matter of attaining them, will become apparent and the present disclosure will be better understood by reference to the following description of various exemplary embodiments of the present disclosure taken in conjunction with the accompanying drawings, wherein:

FIGS. 1-2 show a wearable support device, according to an exemplary embodiment of the present disclosure; and

FIG. 3 shows another embodiment a wearable support device, according to another exemplary embodiment of the present disclosure;

FIG. 4 shows an embodiment of the support device wherein the strap ends are unconnected and the support device is in an open position;

FIG. 5 shows an embodiment of a support device wherein the ends of the strap of connected and the device is in a closed position;

FIG. 6 shows an embodiment of the support device having channels; and

FIG. 7 shows an embodiment of the support device being worn under a protective apron.

An overview of the features, functions and/or configurations of the components depicted in the various figures will now be presented. It should be appreciated that not all of the features of the components of the figures are necessarily described. Some of these non-discussed features, such as various couplers, etc., as well as discussed features are inherent from the figures themselves. Other non-discussed features may be inherent in component geometry and/or configuration.

### DETAILED DESCRIPTION

For the purposes of promoting an understanding of the principles of the present disclosure, reference will now be made to the embodiments illustrated in the drawings, and specific language will be used to describe the same. It will nevertheless be understood that no limitation of the scope of this disclosure is thereby intended.

The terms “lead gown,” “lead apron,” “protective lead clothing,” “protective clothing,” etc. are used interchangeably throughout the specification to refer to heavy clothing worn to protect the user from harmful radiation exposure.

Although the terminology such as “lead gown” or “lead apron” and the above is used, the embodiments within may be used with any heavy protective clothing or even clothing of any weight where it is desired to transfer the load of the clothing away from the shoulders.

Furthermore, it is also envisioned that the embodiments herein may be used generally where it is desired to transfer weight from the shoulders such as, but not limited to, packs, luggage, or any heavy load or item.

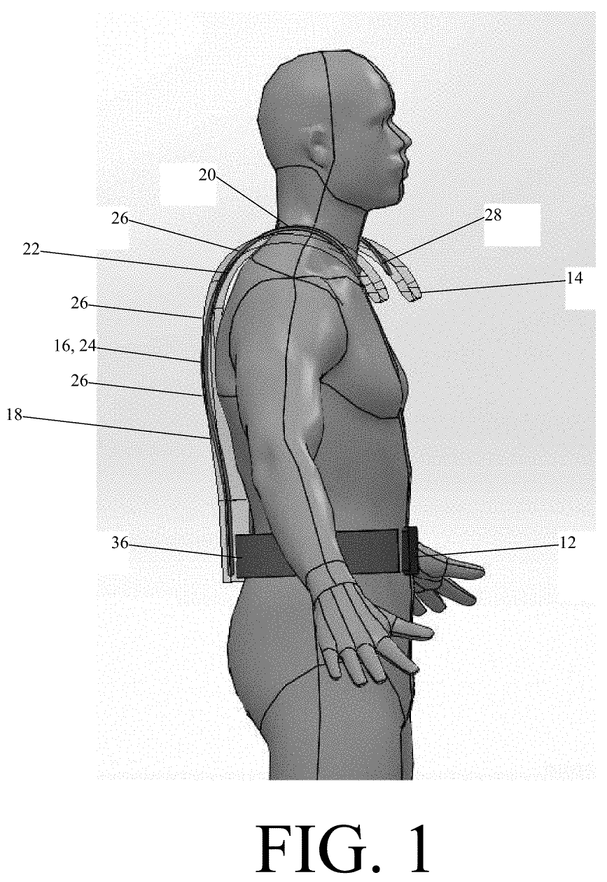

An exemplary device of a lead gown support of the present disclosure is shown in FIG. 1. As shown in FIG. 1, the device comprises a waistband 12, a frame 16 connected to the waistband 12 and a cushion 14 connected to the frame 16.

Now referring to FIG. 1, the waistband 12 is worn around the waist of the wearer. The waistband 12 may be premade to specific dimensions, such as for a custom fit. Preferably, the waistband 12 can be adjustable to be capable of a secure fit and snug fit across a spectrum of wearers. Adjustment may be made manually by adjusting the effective length of the waistband 12, such as through a clasp, or automatically such as by constructing the waistband 12 partially or wholly of elastic material. In the embodiment of FIG. 1 the waistband 12 has a buckle/clasp configured to adjust the waistband 12 length. Where the waistband 12 is configured or adjusted to be snug against the user, this aids in effective transfer of the weight of the lead gown from the shoulders to the waist/hips area of the wearer.

The frame 16 is attached to the waistband 12, and this connection further ensures the effective transfer of the weight of the lead gown away from the wearer's shoulders and back. The frame 16 comprises a generally vertical portion 20 that extends from the waistband 12 upward following the wearer's torso and then further comprises a generally horizontal portion 20 that extends over the shoulder/collarbone of the wearer. Frames 16 may also comprise a transition portion 22 between the generally vertical and generally horizontal portion 20. The transition portion 22 serves the purpose of being contoured to the form of the human shoulders to create a smooth transition between the vertical and horizontal portions 20, rather than a sharp 90 degree angle.

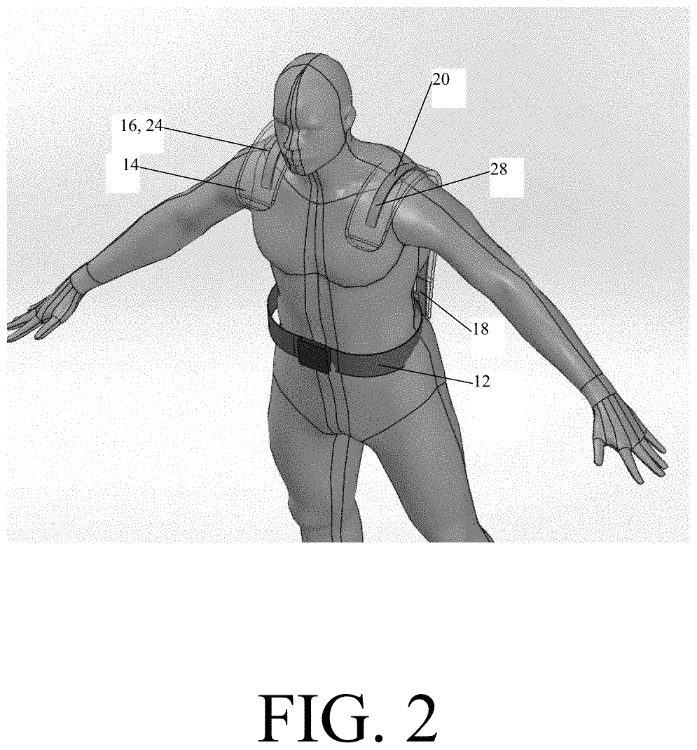

Now referring to FIGS. 1-2, which illustrates an exemplary embodiment, the frame 16 is comprised of two rigid longitudinal stays 24. Each of the two stays 24 are connected at one end to the back/rear 36 of the waistband 12, opposite the buckle 38 and spaced apart so they are bilaterally symmetrical when the embodiment is worn. This has the effect of positioning one stay 24 on each side of a wearer's spine when the lead gown support is worn. The stays 24 comprise a wide and flat shape, being relatively wide when measured across the back of the user and thin or shallow when measured from the front to back of the user. The stays 24 each comprise a generally vertical portion 20 which runs generally parallel along the back of the torso of the wearer in a longitudinal waist-to-head direction. Near the shoulder blade area, the stay 24 begins a transition portion 22, where the vertical portion 20 begins to run in a less vertical direction and into a generally horizontal portion 20. The horizontal portion 20 follows the transition portion 22 and extends over the shoulders/collarbones of the wearer. In the embodiment of FIGS. 1-2, the generally horizontal portion 20 extends into second vertical portion 20 which runs along a length of the front of the torso of the wearer. It is noted that in FIGS. 1-2, the stays 24 comprise contours 26 to follow the general torso shape such as in the lumbar region and in the transition portion 22 over the shoulder region, rather than being strictly 90 degrees to the ground for the generally vertical portion 20 and 180 degrees to the ground for the horizontal portion 20. Furthermore, in the embodiment of FIGS. 1-2 the stays 24 are not resting on the torso or shoulders of the wearer, but are spaced some distance away so as to not cause discomfort and transfer more of the lead gown weight to the hips/waist area.

The function of the frame 16 is to support a heavy lead gown, but it is also a goal of the embodiments herein to reduce the total weight carried by the wearer. Thus the frame 16 is constructed of preferably lightweight material and of such dimensions such that the frame 16 is rigid enough to support lead gown weight, but also lightweight so as to not add to the weight problem. The frame 16 maybe be made of any a suitable lightweight rigid material such as, but not limited to aluminum, titanium, carbon fiber, etc. In a preferred embodiment, the frame 16 or stays 24 are made of aluminum.

Referring again to FIGS. 1-2 an optional cushion 14 is disposed at least partially between the frame 16 and the wearer, thereby preventing the frame 16 from digging into the user and causing pain or injury. The cushion 14 allows the device to be comfortable while being worn. As shown in FIGS. 1-2, the cushion 14 may be integrated with or into the frame 16 while still being disposed toward the interior of the device. A portion of the cushion 14 may also connect to the waistband 12. The cushion 14 may extend beyond the frame/stays 16, 24 in any direction or plane thus being bigger than the frame 16. In a preferred embodiment, the cushion 14 and frame 16 are also positioned such that there is space between the cushion 14 and the body of the wearer so that the cushion ameliorates incidental contact between the device and the wearer during use.

In use the waistband 12 is secured around a wearer and the horizontal portion 20 of the stays 24 positioned over the wearer's shoulders. The waistband is preferably adjusted so as to fit tightly to the wearer. A lead gown (not shown) is worn in a normal fashion and over the device. The gown will rest at least partly on the horizontal portion 20 which is over the shoulders. The weight of the lead gown will be transferred along the generally horizontal component and down the generally vertical component to the waistband 12 where the weight will be shifted to the hips and legs. The muscles in the waist, hips and legs are generally larger, stronger and more durable than the smaller muscles of the upper back and torso. This also has the added benefit of putting less stress on physician arm and hand movement as the shoulders are not as restricted.

Although a device having two bilaterally symmetrical stays 24 is described, the frame 16 may have a variety of shapes as long as it is configured to prevent the weight of the lead gown from resting on the wearer's shoulders and transfer it to the connected portion. i.e. the frame 16 and waistband 12. It is envisioned that the frame 16 could take a variety of shapes. For example, the frame 16 could comprise only one stay 24, or any number of stays 24. The frame 16 could comprise one large stay 24, and the one large stay 24 could be perforated or solid. Instead of only extending partially down the front of the wearer, the frame 16 could extend all the way down the front the wearer and connect to the waistband 12 at both ends. The frame 16 could also extend along the front of the user and/or around the sides. Such variations are within the scope of the invention, and the descriptions herein are not intended to limit said scope.

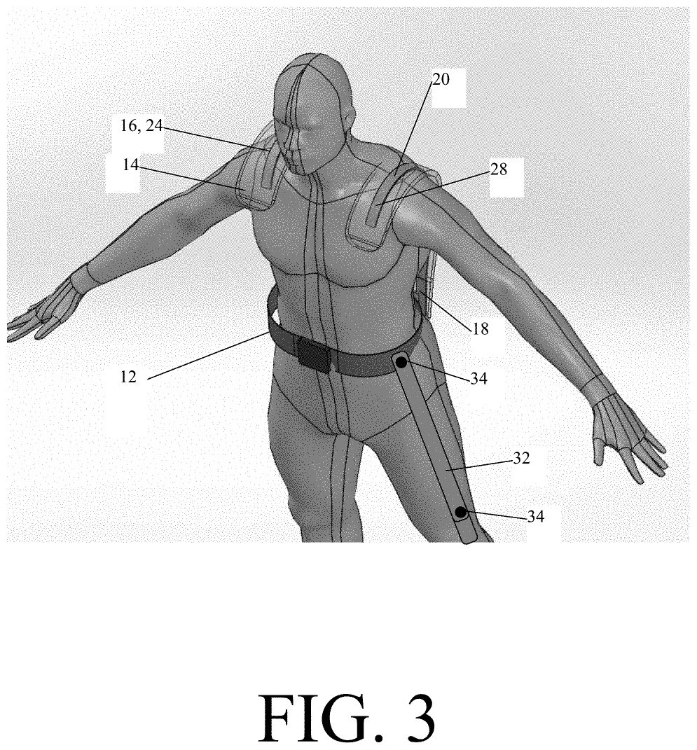

In a further alternate embodiment, the device is substantially as described above, comprising a waistband 12, a frame 16 and a cushion 14, and further comprises two or more post elements connected at a first end to the waistband 12 and at a second end to the ground or floor as shown in FIG. 3. Alternatively the second end may be connected to a load bearing surface, wherein the surface is preferably horizontal. Exemplary support surfaces include, but are not limited to the floor or ground, a wall, an operating table, and any stable structure that may be near locations where a protective gown is worn. The post elements 32 may also be fully articulated, comprising one or more joints 34 positioned on the post element to mirror the joints of a human leg, such as at the knee and/or ankle. The post elements aid in weight transfer and provide additional weight support for a heavy load as described within and may be powered or provide passive support/assistance. Exemplary embodiments include, hydraulic/gas lifts, electric motors, counterweights etc. or combinations of such.

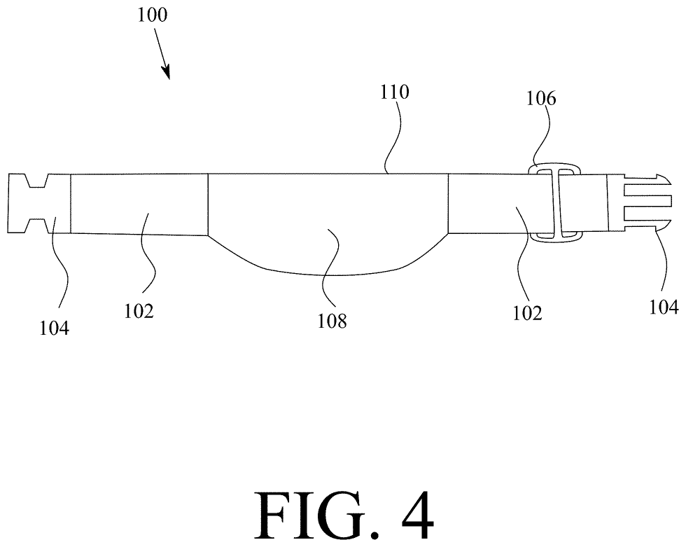

In another embodiment 100 of the invention, the device 100 comprises a securing portion 102, such as a strap 102 for encircling a wearer around their waist, and a bolster 108, such as a cushion or padding, disposed thereon as shown in FIGS. 4-7. In this form the embodiment takes on a form generally resembling a belt, waistband or cummerbund, and the like.

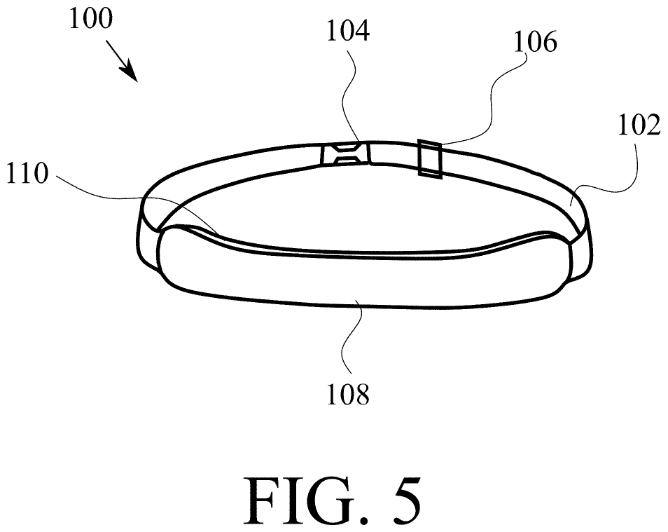

The bolster 108 is disposed on a securing portion 102. The securing portion 102 may be a strap configured to encircle the waist of a wearer and hold the bolster 108 close to the body of the wearer. The securing portion 102 may further comprise a closure 104, and an adjustment 106. The closure 104 is positioned at least on or near one end of the strap 102 and used to connect the ends of the strap 102 together thereby forming a circumference, such as in FIG. 5. The adjustment 106 can be disposed on the strap or as part of the closure. The adjustment 106 allows for the sizing of the circumference of a closed strap 102 and for positioning of the bolster 108 relative to the wearer's back. Adjusting can be performed so that the device 100 is securely fastened around the waist of the wearer and the bolster 108 is positioned properly as described below (against the back and lumbar region of the wearer).

Additionally, the closure 104 and adjustment 106 may be any fastener or adjuster as known in the art: buckles, hook and loop, ties, hooks, etc. Use of the adjustment provides for a comfortable and secure fit for the wearer. The strap 102 may be comprised of elastic material but is preferably comprised of inelastic material as the adjustment 106 would be capable of providing sufficient length correction and a tight fit is desired.

The bolster 108 is located on a strap 102 of the securing portion so that when the device 100 is worn, the bolster 108 is positioned over the lower back of the wearer such as in the lumbar region. The bolster 108 can also be positioned in the vicinity of the lumbar area, such as in the area immediately above or below the lumbar area. The bolster 108 may also cover a portion of the lumbar area and some of the area immediately lower or higher, or cover the lumbar area and both lower and higher areas.

The bolster 108 extends laterally in a direction along the strap 102 such that the entire dorsal side of the wearer is covered. For example, the bolster 108 can terminate at the midpoints between the anterior and posterior side of the wearer. In this case, the bolster 108 would extend only along half or slightly less than half of the closed strap 102. In other embodiments, the bolster 108 can extend farther along the strap 102 and around the wearer to cover some or all of the wearer's anterior side. The bolster 108 could also be limited to the dorsal side of a wearer, such as extending less than the dorsal, or backside. In this embodiment, the bolster 102 would have a length less than half of the total strap length.

As the device 100 is intended to be worn around the waist, the bolster will have a lateral length reflecting the waist sizes or portions of the waist sizes of the wearer. Some non-inclusive exemplary lengths can include 12 cm, 40, cm 100, cm, 120 cm, 150 cm and the like.

The bolster 108 also has a dimension extending upwards and downwards, or superiorly and inferiorly along the wearer, when worn. The bolster 108 may have rectangular shape, but may also be shaped ergonomically. For example, an elliptical shape or a generally rectangular shape having one or more curved sides or corners may be used. The shape of the bolster 108 may also comprise other suitable irregular shapes to conform to the wearer as desired.

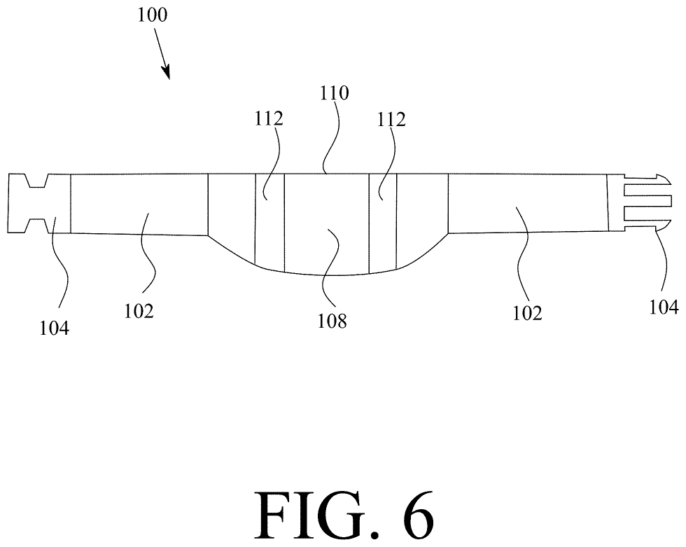

The bolster 108 may also have one or more channels 112 to allow for the straps of a lead gown to rest within as shown in FIG. 6.

The bolster is preferably comprised of a relatively semi-firm material. The material should be sufficiently firm to hold at least part of a lead apron, wherein a lead apron could weigh up to around 17 lbs. Other embodiments could hold aprons/gowns of a higher weight. Since only a portion of the apron would rest on the shelf of the bolster, the shelf could also be able to hold a lower weight. In addition, the material should be sufficiently flexible such that it can conform to the contours of the wearer when secured around the waist.

Support is at least partially provided by an upper portion of the bolster 108 having a dimension that forms a shelf 110 which extends perpendicular and posteriorly away from the dorsal side of the wearer and strap 102, when worn. The upper, or superior, side of the bolster 108 forms a shelf 110 wherein the perpendicular dimension of the shelf 110 is sufficient such that an article of clothing above it, such as a lead gown 114, may be supported by the shelf. For example, the shelf's dimension may range preferably from 0.1-4.0 cm and be 0.5 cm, 1 cm, or 3 cm. It is further envisioned that other sizes lesser or smaller, are available, such as 0.05 cm, 5 cm, 7 cm, and the like. The shelf 110 may extend laterally along the full length of the bolster 108, or only for a portion of the bolster 108, thereby creating a taper along the bolster 108.

The dimensions and composition of the bolster 108 allow for the device 100 to be comfortable against a wearer's body and also be sufficiently firm to support a portion of a lead gown 114 that is worn over the bolster 108. The inherent stiffness of a lead gown would assist in the transfer of the weight from the shoulders of the wearer to the shelf and ultimately the wearer's hips.

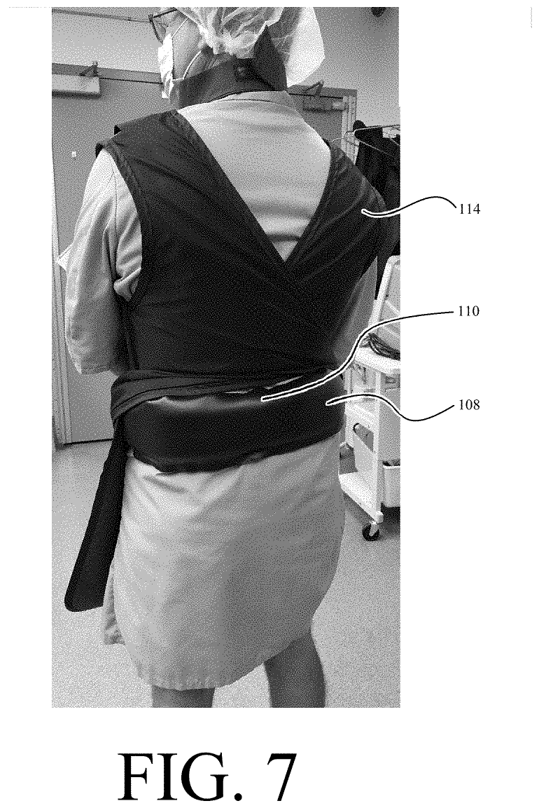

In a method of use, as illustrated in FIG. 7, the device 100 is wrapped around the waist and secured using the closure 104 on the strap 102. The resulting circumference of the securing portion 102 is adjusted using the adjustment 106 such that the device 100 is snug against the wearer and the bolster 108 is positioned on the dorsal side of the wearer and the lumbar area above, and/or below the lumbar is covered as desired. After positioning and closing the strap 102, a lead apron 114 may be worn in a normal fashion. As the lead apron 114 is put on after the described device 100, the apron is considered to be worn “over” the device.

Without a support device of the present disclosure, the lead apron 114 drapes freely down across the body. In this case, the weight of the apron 114 is supported mostly on the shoulders. As mentioned above, a lead apron 114 can be relatively heavy, and when worn for a long period of time, such as during surgical procedures, the stress upon the body can cause back pain and further develop into career ending injuries.

In the present disclosure, the device 100 is worn under the lead apron 114. When the apron 114 is put on in a normal fashion, it will rest at least partly on the device 100. In particular, the apron will rest on the support section of the device instead of draping freely across the body. Of note, the device 100 therefore does not clamp the apron 114 against the body of the wearer. In this manner the apron is positioned at least partly superior to, or above, the support device and the apron is thus supported in part by the shelf of the bolster. The support device can be adjusted higher or lower and the bolster sized for each individual wearer as needed to properly support the apron.

As a result of the positioning of the support device and the apron, the apron weight is shifted from the shoulders and back to the hips. The larger muscles of the hips and legs are better able to hold this weight. Thus, the device reduces instances of injury from extended wearing of lead aprons.

While various embodiments of devices for lead gown support and methods for using the same have been described in considerable detail herein, the embodiments are merely offered as non-limiting examples of the disclosure described herein. It will therefore be understood that various changes and modifications may be made, and equivalents may be substituted for elements thereof, without departing from the scope of the present disclosure. The present disclosure is not intended to be exhaustive or limiting with respect to the content thereof.

Further, in describing representative embodiments, the present disclosure may have presented a method and/or a process as a particular sequence of steps. However, to the extent that the method or process does not rely on the particular order of steps set forth therein, the method or process should not be limited to the particular sequence of steps described, as other sequences of steps may be possible. Therefore, the particular order of the steps disclosed herein should not be construed as limitations of the present disclosure. In addition, disclosure directed to a method and/or process should not be limited to the performance of their steps in the order written. Such sequences may be varied and still remain within the scope of the present disclosure.

1. A support device for supporting a heavy article of clothing, such as a lead apron or gown, worn over the support device, comprising:
a strap having a closure disposed thereupon, the closure configured to connect the strap thereby forming a circumference; and
a bolster disposed on the strap.

2. The device of claim 1, wherein the bolster comprises a shelf on an upper side of the bolster.

3. The device of claim 2, wherein the bolster is comprised of a semi-firm material.

4. The device of claim 3, wherein the closure is attached at or near an end of the strap.

5. The device of claim 4, wherein the strap comprises two ends; the strap comprises a closed position; and wherein in the closed position the closure connects a point on or near each of the two ends of the strap together to form the circumference.

6. The device of claim 5, wherein an adjustment is disposed on the strap and configured to increase or decrease the circumference of the strap.

7. The device of claim 5, further comprising at least one channel in the bolster.

8. A support device for supporting a heavy article of clothing, such as a lead apron or gown, worn over the support device, comprising:
a circumferential strap having a closure; and
a bolster disposed on the strap wherein the bolster is comprised of a semi-firm material and forms a shelf on the upper side of the bolster.

9. The device of claim 8, wherein the bolster is disposed on the circumferential strap diametrically opposite the closure.

10. The device of claim 9, wherein the bolster extends for at least half the circumference of the strap.

11. The device of claim 10, wherein the strap has an adjustment configured to increase or decrease the circumference of the strap

12. The device of claim 11, wherein the bolster comprises a generally rectangular or elliptical shape.

13. The device of claim 12, further comprising at least one channel in the bolster.

14. The device of claim 13, wherein the bolster comprised of semi-firm material is sufficiently firm to support a lead apron on the shelf of the bolster.

15. The device of claim 14, wherein the bolster is flexible.

16. The device of claim 8, wherein the bolster extends for more than half the circumference of the strap.

17. The device of claim 8, wherein the bolster extends for less than half the circumference of the strap.

18. The device of claim 8, wherein the strap is comprised of an inelastic material.

19. A method of using a support device for supporting a lead apron or gown, the method comprising the steps of:
positioning the support device around the waist of a wearer, wherein the support device comprises a bolster and the bolster has a shelf on an upper side of the bolster;
positioning the bolster on the dorsal side of the wearer; and
wearing a lead apron or gown after positioning the support device around the waist of a wearer, wherein at least part of the lead apron or gown rests upon the shelf of the bolster.

20. The method of using a support device for supporting a lead apron or gown as in claim 19, further comprising the step of positioning the support device around the waist of a wearer such that the bolster is covering the lower back of a wearer.
